(19) United States
(12) Patent Application Publication
(10) Pub. No.: US 2026/0172435 A1
(43) Pub. Date: Jun. 18, 2026

(54) SYSTEM AND METHODS OF ANALYZING COMMUNICATIONS USING LINGUISTIC PATTERN RECOGNITION AND DYNAMIC QUESTIONING

(71) Applicant: Deceptio.ai LLC, St. Petersburg, FL (US)

(72) Inventors: Mark Steven Carson, St. Petersburg, FL (US); Mark Alan McClish, Charlotte, NC (US); Michael McClish, Charlotte, NC (US)

(73) Assignee: Deceptio.ai LLC, St. Petersburg, FL (US)

(21) Appl. No.: 19/421,438

(22) Filed: Dec. 16, 2025

Related U.S. Application Data
(60) Provisional application No. 63/734,636, filed on Dec. 16, 2024.

(51) Int. Cl. H04L 9/40; G06F 40/253; G06F 40/279; G06F 40/35; G06F 40/40; G06V 20/40; G06V 40/20; G10L 25/63

(52) U.S. Cl. CPC H04L 63/1425; G06F 40/253; G06F 40/279; G06F 40/35; G06F 40/40; G06V 20/40; G06V 40/20; G10L 25/63; H04L 63/30

(57) ABSTRACT

A system and method for AI-driven deception detection through interactive statement analysis. The system receives statements via multiple modalities and analyzes them using linguistic pattern algorithms that identify deception indicators including pronoun usage patterns, temporal inconsistencies, narrative structure anomalies, and lack of sensory detail. Unlike prior fact-checking systems that verify factual accuracy against databases or content analysis systems that detect policy violations, the present invention identifies deceptive intent through linguistic analysis independent of external verification. An AI avatar dynamically generates contextually-relevant follow-up questions based on detected deception indicators, creating an iterative questioning process that progressively refines deception assessment across multiple interaction cycles. Field-specific deception detection models are applied across specialized domains including insurance claims, witness testimony, and employment screening. The system integrates multimodal analysis of text, speech patterns, and video, providing real-time deception assessment during live interactions.

### CROSS-REFERENCE TO RELATED APPLICATIONS

This application claims the benefit of priority under 35 U.S.C. § 119(e) to U.S. Provisional Patent Application No. 63/734,636, filed Dec. 16, 2024, entitled “Artificial Intelligence Software and System for Identifying Deception in Written and Spoken Statements,” the entire contents of which are incorporated herein by reference.

### BACKGROUND

The present invention relates generally to artificial intelligence systems for use in analyzing communications, and more particularly to systems and methods for detecting deception through interactive statement analysis using linguistic pattern recognition and dynamic questioning.

Deception detection has long been a challenge across numerous fields including law enforcement, insurance claims processing, employment screening, witness testimony evaluation, and interpersonal relationship assessment. Traditional approaches to deception detection have relied primarily on physiological measurements such as polygraph testing, which measures heart rate, blood pressure, respiration, and skin conductivity. However, these approaches have significant limitations including susceptibility to countermeasures, inability to distinguish between general anxiety and deception-specific stress, and lack of applicability to remote or asynchronous communications.

More recently, various technological approaches have attempted to address deception detection through an automated means. However, at least some known automated systems have attempted to analyze communication content for various purposes that differ fundamentally from comprehensive deception detection. For example, at least some known prior art systems detect problematic statements in written communications using machine learning models that focus primarily on tone analysis and/or inappropriate language detection for purposes of content moderation or policy enforcement. As a result, such systems typically identify offensive language, inappropriate tone, or policy violations rather than analyzing linguistic patterns specifically correlated with deceptive intent.

Other known prior art systems perform fact-checking during phone calls or on written documents by verifying statements against third-party databases or external reference sources. While these systems can determine whether a statement matches known factual information, they suffer from significant limitations when applied to deception detection contexts. Generally, these fact-checking systems rely on external verification against databases and cannot detect deception when the factual content is accurate but the manner of presentation is deceptive. For example, a person can make factually accurate statements while still being deceptive through omission, misdirection, or manipulative framing. Conversely, a person may make factually inaccurate statements due to an honest mistake or a faulty memory rather than through deceptive intent. Thus, factual accuracy and truthfulness are related but distinct concepts that require different analytical approaches.

At least some other known systems use sensor fusion and neural networks to enhance human-computer interactions, such as smart speaker systems that determine whether speech is directed to a device. These systems focus on determining user intent to interact with a device through analysis of non-verbal attention indicators such as gaze detection, proximity, and sound energy levels. However, such systems serve an entirely different purpose—determining whether a user intends to interact with a device—rather than assessing the truthfulness or deceptive nature of statements made during interactions.

These existing approaches generally suffer from several critical limitations when applied to deception detection. First, known systems that analyze communication content typically focus on detecting policy violations, inappropriate language, or factual inaccuracies against known databases, rather than identifying deceptive intent through linguistic pattern analysis. They lack specialized algorithms for detecting deception-specific linguistic markers such as pronoun distancing, temporal vagueness, narrative inconsistencies, and lack of sensory detail that are empirically correlated with deceptive communication. In addition, existing fact-checking systems rely on external verification against third-party sources and cannot detect deception when the factual content is accurate but the manner of presentation is deceptive. They analyze what is said (content verification) rather than how it is said (linguistic pattern analysis indicative of deception). Such systems are fundamentally limited to comparing statements against reference databases and cannot operate independently when such databases are unavailable or when deception occurs through accurate-but-misleading statements.

Moreover, conversational AI systems that use sensor fusion and neural networks focus on determining user intent to interact with a device (attention detection), not on assessing whether the user's statements are truthful. The sensor fusion in these systems analyzes gaze direction, proximity, and sound energy to determine interaction intent, which is fundamentally different from analyzing linguistic patterns to determine truthfulness. In addition, existing systems may provide only passive analysis of completed communications rather than conducting real-time interactive analysis with adaptive questioning. Such systems cannot generate dynamic, context-aware follow-up questions to probe inconsistencies or elicit additional deceptive indicators. This limitation prevents progressive refinement of deception assessments through iterative questioning.

Furthermore, known systems lack field-specific deception detection capabilities. Deception manifests differently across specialized domains—the linguistic patterns indicative of insurance fraud differ from those in witness testimony, which differ from those in employment screening contexts. General-purpose content analysis systems cannot account for these domain-specific variations. Accordingly, such systems do not provide comprehensive multimodal analysis specifically designed for deception detection. While some systems may process multiple input types (text, audio, video), they do so for general content understanding or interaction intent detection rather than for identifying deception-specific indicators across modalities.

Accordingly, there remains a need for an AI-driven deception detection system that can analyze statements in real-time, identify deception through linguistic pattern analysis independent of external verification, generate adaptive follow-up questions to probe detected inconsistencies, and provide field-specific deception assessment across multiple communication modalities.

### BRIEF SUMMARY

In one aspect, a system for deception detection is provided. The system includes an input interface configured to receive statements from subjects via multiple modalities, a deception detection engine comprising one or more processors executing linguistic pattern analysis algorithms, an AI avatar module configured to generate and present dynamic follow-up questions, a response analysis module configured to analyze responses and identify additional deception indicators, an iterative questioning controller configured to manage multiple cycles of questioning and analysis, a field-specific model database storing specialized deception detection models, and an output interface configured to provide deception assessment results.

In another aspect, a method for deception detection is provided. The method includes receiving, by a computing system, a statement from a subject via at least one input modality selected from text input, speech-to-text conversion, video analysis, email, or SMS messaging. The computing system analyzes the statement using one or more processors executing deception detection algorithms to identify one or more deception indicators, wherein the deception indicators include linguistic patterns specifically correlated with deceptive intent. One or more follow-up questions are generated based on the identified deception indicators and presented to the subject in real-time. The computing system receives responses to the follow-up questions, analyzes the responses to identify additional deception indicators, and determines a deception assessment based on the deception indicators identified in the statement and the additional deception indicators identified in the responses

### BRIEF DESCRIPTION OF THE DRAWINGS

FIG. 1 is a block diagram illustrating an exemplary architecture of a deception detection system in accordance with an embodiment of the present invention.

FIG. 2 is a flowchart illustrating an exemplary method that may be implemented using the architecture of FIG. 1 for detecting deception through interactive statement analysis.

FIG. 3 is an exemplary block diagram illustrating the deception detection engine components that may be used with the architecture of FIG. 1.

FIG. 4 is a flowchart illustrating an exemplary iterative questioning process that may be implemented using the architecture of FIG. 1.

FIG. 5 is a diagram illustrating an exemplary multimodal input processing that may be implemented using the architecture of FIG. 1.

FIG. 6 is a diagram illustrating an exemplary field-specific deception detection model selection that may be implemented using the architecture of FIG. 1.

FIG. 7 is a block diagram illustrating an exemplary AI avatar question generation module that may be used in the architecture of FIG. 1.

FIG. 8 is a diagram illustrating an exemplary linguistic pattern analysis for deception detection that may be used in the architecture of FIG. 1.

### DETAILED DESCRIPTION

In the following specification and the claims, reference will be made to a number of terms, which shall be defined to have the following meanings. In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

The singular forms “a”, “an”, and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but is not limited to only including, a computer-readable medium, such as a random-access memory (RAM), a computer-readable non-volatile medium, such as a flash memory. Alternatively, a floppy disk, a compact disc read-only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the example embodiment, additional output channels may include, but are not limited to only including, an operator interface monitor.

Further, as used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are exemplary only and are thus not limiting as to the types of memory usable for storage of a computer program.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

Moreover, as used herein, the term “database” may refer to either a body of data, a relational database management system (RDBMS), or to both. A database may include any collection of data including hierarchical databases, relational databases, flat file databases, object-relational databases, object-oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California).

Generally, the embodiments described herein address the limitations of known systems by providing a comprehensive AI-driven deception detection system that analyzes statements through linguistic pattern recognition and conducts interactive, iterative questioning to assess truthfulness in the communication. Unlike known systems that merely detect inappropriate content or verify factual accuracy against databases, the present invention uniquely identifies deceptive intent through linguistic pattern analysis, including, but not limited to, pronoun usage patterns, temporal inconsistencies, narrative structure anomalies, emotional language markers, and sensory detail deficiencies that are specifically correlated with deception rather than mere inaccuracy or policy violations. Furthermore, unlike passive analysis systems, the present invention provides an interactive AI avatar that dynamically generates contextually relevant follow-up questions in real-time based on detected deception indicators, creating an iterative questioning process that progressively refines the deception assessment. This interactive capability distinguishes the invention from static content analysis systems that cannot adapt their analysis based on evolving conversational context.

In one embodiment, a computer-implemented method for deception detection includes receiving, by a computing system, a statement from a subject via at least one input modality selected from text input, speech-to-text conversion, video analysis, email, or SMS messaging. The computing system analyzes the statement using one or more processors executing deception detection algorithms, to identify one or more deception indicators, wherein the deception indicators include linguistic patterns specifically correlated with deceptive intent, including at least one of: pronoun usage patterns indicative of psychological distancing, temporal vagueness markers, narrative structure inconsistencies, lack of sensory detail, or emotional language anomalies. One or more follow-up questions are generated based on the identified deception indicators. In one embodiment, contextually relevant questions are dynamically generated in real-time based on the specific type of deception indicator detected. Moreover, the follow-up questions are adapted to probe inconsistencies identified in the statement. The follow-up questions are presented to the subject in real-time, and the computing system receives responses to the follow-up questions in real-time. The responses are then analyzed to identify additional deception indicators and a deception assessment, based on the deception indicators identified in the statement and the additional deception indicators identified in the responses, is generated.

The deception detection algorithms may include a combination of linguistic pattern analysis algorithms and machine learning models trained on deception-labeled datasets. The linguistic patterns may include an analysis of first-person pronoun usage frequency, verb tense consistency, specificity of temporal references, presence and detail level of sensory descriptions, narrative coherence metrics, and emotional language congruence with stated facts. In some embodiments, analyzing the statement to identify deception indicators is performed independently of an external database verification, wherein the deception indicators are identified through linguistic pattern analysis of the statement itself, rather than through a comparison to external reference sources. The independence from external verification enables the system to detect deception even when factually accurate statements are presented in a deceptive manner and enables operation in contexts where external verification sources are unavailable.

The system may distinguish between factually inaccurate statements and deceptively presented statements, wherein a factually accurate statement may be identified as deceptive based on linguistic presentation patterns, and wherein a factually inaccurate statement may be identified as non-deceptive when linguistic patterns indicate honest mistake rather than intentional deception.

In some embodiments, the AI avatar conducts iterative questioning across multiple interaction cycles, wherein each subsequent question is generated based on deception indicators detected in responses to previous questions, thus creating a progressive refinement of the deception assessment. The iterative process may continue until a confidence threshold is reached, a predetermined number of interaction cycles is completed, and/or the subject terminates the interaction.

The deception detection may be field-specific, wherein different deception detection models are applied based on a determined context selected from specialized fields including, but not limited to only including, insurance claims, witness testimony, employment screening, financial fraud, relationship contexts, legal proceedings, security clearance interviews, medical history verification, academic integrity assessment, customer service interactions, investigative journalism, background checks, asylum claims, child custody evaluations, elder abuse investigations, workplace harassment claims, product liability claims, intellectual property disputes, contract negotiations, merger and acquisition due diligence, regulatory compliance interviews, and/or forensic accounting investigations.

In some embodiments, the deception detection system 100 may be deployed in military and defense applications, including integration into militarized humanoid systems configured to perform functions of human warfighters in combat environments. In such embodiments, the system 100 may be configured to interact with foreign nationals, interpret foreign languages, convert foreign language statements to a target language (such as English), analyze the converted statements for deception indicators, and/or present actionable intelligence to warfighters or command personnel. The militarized humanoid may incorporate the deception detection system 100 as a cognitive module executing within the humanoid's processing architecture, enabling real-time deception detection during field interrogations, checkpoint interactions, intelligence gathering operations, and/or other military scenarios.

In some embodiments, the deception detection system 100 may be deployed across a local-only mesh network to edge devices in austere environments. Edge deployment enables the system 100 to operate without cloud dependency, maintaining full functionality despite loss of internet connectivity, GPS disruption, or operation in contested environments. Edge units may run the deception detection algorithms directly on-site, handling sensing, decision-making, and coordination locally. All data may remain within the local mesh network or local area network (LAN), ensuring resilience, low latency, and security. The edge deployment architecture may include multiple edge devices communicating via mesh networking protocols, with each edge device capable of performing deception detection independently or in coordination with other edge devices.

The deception detection system 100 may be configured to operate in multiple operational modes, including human-assisted mode, fully autonomous mode, and hybrid mode that transitions between human-assisted and autonomous operation.

In human-assisted mode, the system 100 performs deception detection in coordination with one or more human operators. The system 100 may receive human-provided inputs, confirmations, or adjustments during execution. For example, a human operator may review deception assessments generated by the system 100, confirm or override deception indicator identifications, approve follow-up questions before presentation to subjects, adjust field-specific model selections, or provide feedback that refines the system's operation. The human-assisted mode enables human judgment and expertise to augment the automated deception detection capabilities.

In fully autonomous mode, the system 100 performs deception detection automatically without requiring human intervention. The system 100 independently generates, selects, and executes all operations necessary to achieve deception detection, including receiving statements, analyzing statements for deception indicators, generating follow-up questions, presenting questions to subjects, analyzing responses, conducting iterative questioning, and determining final deception assessments. The fully autonomous mode enables operation in scenarios where human operators are unavailable, where response speed requirements preclude human involvement, or where operational security considerations require minimizing human exposure.

In hybrid mode, the system 100 operates in a selectable or adaptive mode that transitions between human-assisted operation and fully autonomous operation. The system 100 may determine, request, or reduce human involvement based on internal logic, performance thresholds, contextual conditions, or predefined criteria. For example, the system 100 may operate autonomously for routine deception detection tasks but request human review for high-stakes assessments, ambiguous cases, or when confidence levels fall below defined thresholds. Alternatively, the system 100 may begin in human-assisted mode and transition to autonomous mode as the system gains confidence through machine learning or may transition from autonomous to human-assisted mode when encountering novel scenarios or detecting potential system errors. The hybrid mode may be configured by system operators to define conditions under which mode transitions occur or may adaptively determine appropriate modes based on real-time analysis of operational conditions.

In embodiments involving foreign language processing, the deception detection system 100 may include or interface with language translation modules configured to receive statements in a source language and convert them to a target language for analysis. The language translation may be performed using machine translation algorithms, neural machine translation models, or other translation technologies. In some embodiments, the deception detection engine 120 may analyze statements in the original source language using language-specific deception detection models trained on deception patterns in that language. In other embodiments, statements may be translated to a common target language (such as English) and analyzed using deception detection models for the target language. The system 100 may account for translation artifacts or cultural differences in communication patterns when analyzing translated statements for deception indicators.

In military applications, the foreign language processing capability enables militarized humanoids or other military systems to interact with foreign nationals in their native languages, perform real-time translation, and conduct deception detection on the translated content to generate actionable intelligence for warfighters. The system 100 may support multiple languages simultaneously, enabling operation in multilingual environments.

The deception detection system 100 may be specifically configured for operation in austere and contested environments where traditional computing infrastructure is unavailable or unreliable. Austere environments may include remote locations lacking internet connectivity, power infrastructure, or communication networks. Contested environments may include combat zones, areas with active electronic warfare, or locations where adversaries attempt to disrupt communications or computing systems.

For operation in such environments, the system 100 may be deployed on ruggedized edge computing devices with local power sources (batteries, solar panels, generators), local data storage, and mesh networking capabilities that enable device-to-device communication without reliance on centralized infrastructure. The system 100 may implement data synchronization protocols that enable edge devices to share deception detection models, field-specific models, and operational data when connectivity is available, while maintaining full operational capability when isolated.

The system 100 may implement security measures appropriate for contested environments, including encrypted communications, tamper-resistant hardware, secure boot processes, and data destruction capabilities to prevent adversary access to sensitive deception detection algorithms or operational data.

The system may process multimodal inputs simultaneously, wherein text analysis, speech pattern analysis, and video analysis are integrated to provide a comprehensive deception assessment. Video analysis may include detection of micro-expressions, eye movement patterns, and body language indicators correlated with deception. Speech pattern analysis may include voice stress analysis, speech rate variations, and vocal pitch changes. The multimodal indicators may be weighted and combined according to field-specific models to generate an overall deception score.

In another embodiment, a system for AI-driven deception detection includes: an input interface configured to receive statements from subjects via multiple modalities including text, speech, video, email, and SMS; a deception detection engine including one or more processors executing linguistic pattern analysis algorithms designed to identify deception indicators; an AI avatar module configured to generate and present dynamic, contextually-relevant follow-up questions based on detected deception indicators; a response analysis module configured to analyze responses to follow-up questions and to identify additional deception indicators; an iterative questioning controller configured to manage multiple cycles of questioning and analysis; a field-specific model selector configured to apply appropriate deception detection models based on determined context; and an output interface configured to provide real-time deception assessment feedback.

The system may integrate both deception detection algorithms and open-source large language models (LLMs) for question generation, wherein the algorithms identify deception indicators and the LLMs generate natural language questions designed to probe the identified indicators.

In accordance with yet another aspect of the invention, a processor includes a non-transitory computer-readable storage medium having program instructions embodied therewith, the program instructions executable by one or more processors to cause the processors to perform the methods described herein.

The present invention provides systems and methods for AI-driven deception detection through interactive statement analysis. The invention analyzes statements using linguistic pattern recognition algorithms specifically designed to identify deception indicators, and employs an AI avatar to conduct dynamic, adaptive questioning that progressively refines deception assessments through iterative interaction cycles.

Key advantages include, for example and as described in more detail below, deception-specific analysis, interactive adaptive analysis, linguistic pattern analysis, field-specific models, multimodal integration for deception detection, real-time operation, and/or scalability. Unlike general content analysis systems, the present invention utilizes deception-specific analysis and specifically targets deception detection through linguistic patterns empirically correlated with deceptive intent, providing higher accuracy for deception detection applications as compared to known systems that are designed for policy enforcement or sentiment analysis. Moreover, unlike known systems that analyze completed communications, the present invention conducts real-time interactive analysis, generating adaptive follow-up questions that probe detected inconsistencies, resulting in progressively refined deception assessments through iterative questioning cycles. This is a process known as an interactive adaptive analysis.

In addition, unlike known fact-checking systems that require external databases for verification, the present invention operates independently through linguistic pattern analysis, enabling deception detection even when external verification sources are unavailable or when factually accurate statements are deceptively presented. Furthermore, the system maintains specialized deception detection models for multiple fields, i.e., field-specific models, recognizing that deception manifests differently across domains, providing superior accuracy compared to general-purpose analysis systems. Although prior systems may process multiple input types, the present invention specifically integrates multimodal analysis to detect deception-specific indicators across modalities, rather than for general content understanding or interaction intent detection. Moreover, the system provides immediate feedback during live interactions, enabling real-time decision-making in contexts such as live interviews, customer service interactions, or security screenings. Furthermore, the system can process statements from multiple subjects simultaneously, making it suitable for large-scale applications such as insurance claim processing or employment screening.

These and other features and advantages of the present invention will become apparent from the following detailed description of preferred embodiments, taken in conjunction with the accompanying drawings.

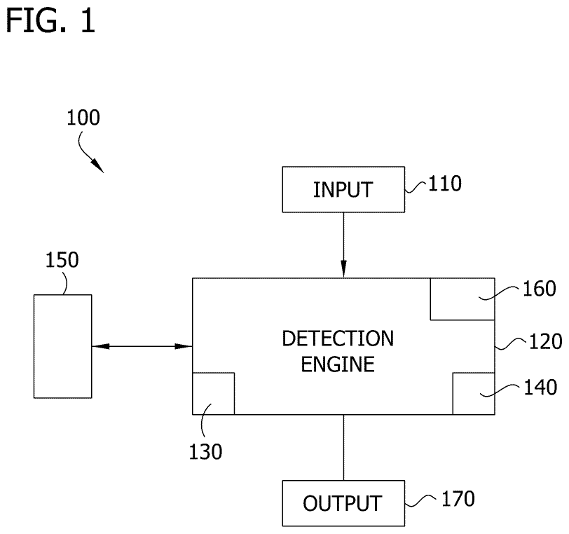

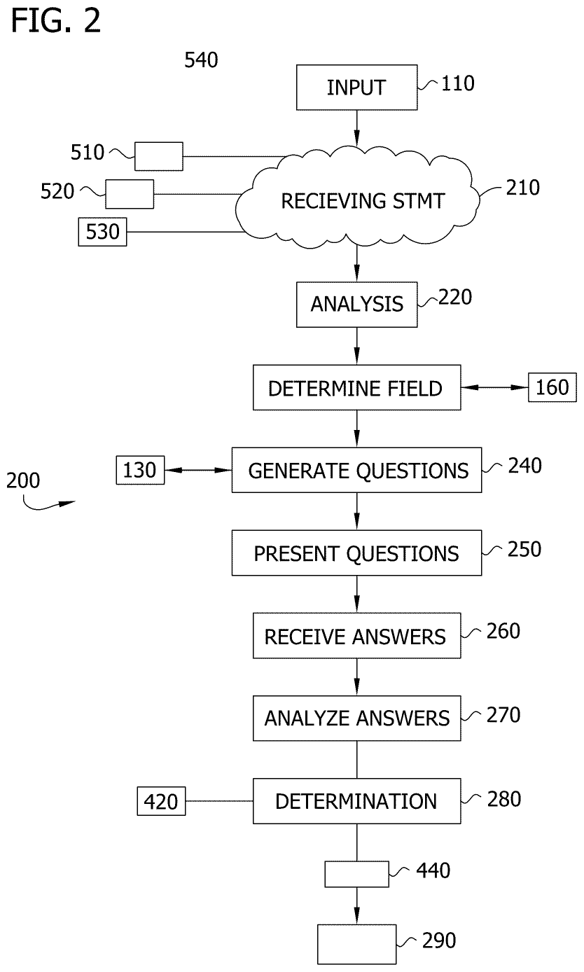

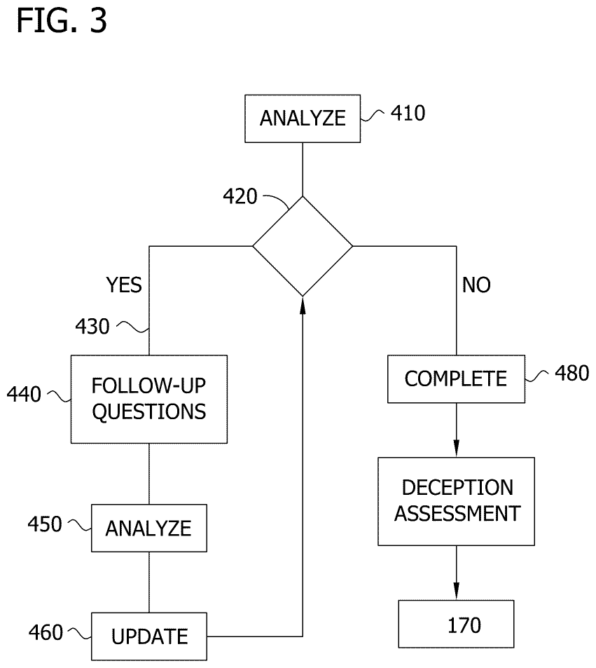

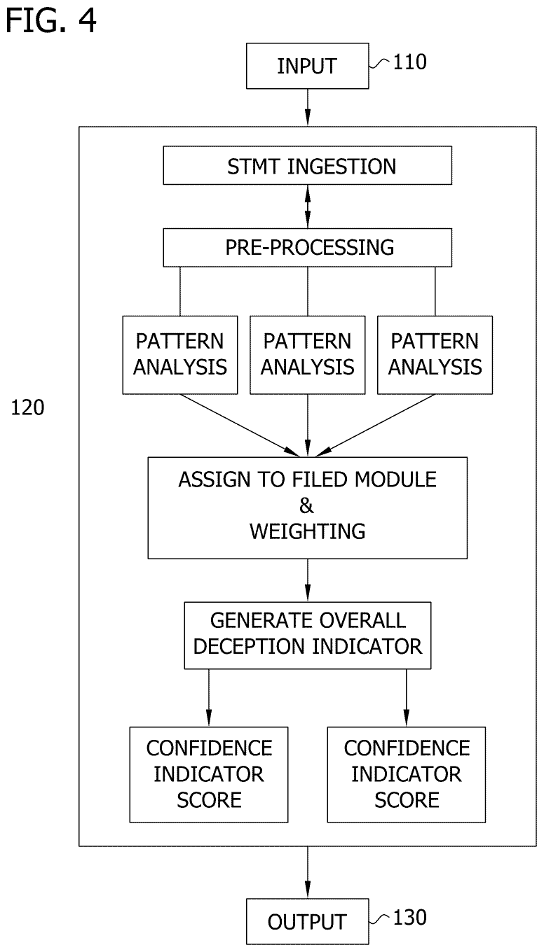

FIG. 1 is a block diagram illustrating an exemplary architecture of a deception detection system 100 in accordance with an embodiment of the present invention. FIG. 2 is a flowchart illustrating an exemplary method that may be implemented using the deception detection system 100. FIG. 3 is an exemplary block diagram illustrating the deception detection engine components that may be used with deception detection system 100. FIG. 4 is a flowchart illustrating an exemplary iterative questioning process that may be implemented using deception detection system 100. FIG. 5 is a diagram illustrating an exemplary multimodal input processing that may be implemented using deception detection system 100. FIG. 6 is a diagram illustrating an exemplary field-specific deception detection model selection that may be implemented using deception detection system 100. FIG. 7 is a block diagram illustrating an exemplary AI avatar question generation module that may be used with deception detection system 100. FIG. 8 is a diagram illustrating an exemplary linguistic pattern analysis for deception detection that may be used with deception detection system 100.

In the exemplary embodiment, the deception detection system 100 is an artificially intelligent (AI)-driven system. The system, in the exemplary embodiment, includes an input interface 110, a deception detection engine 120, an AI avatar module 130, a response analysis module 140, an iterative questioning controller 150, a field-specific model database 160, and an output interface 170. The deception detection system 100 may be implemented on one or more computing devices comprising processors, memory, storage, and/or network interfaces as is known in the art.

In the exemplary embodiment, the input interface 110 receives statements from subjects via multiple modalities. For example, in various embodiments, the input interface 110 may accept text input or entered directly by a subject, speech input that is converted to text via speech-to-text processing, video input that is analyzed for both verbal content and visual deception indicators, email messages, SMS messages, and/or any combination thereof. The input interface 110 may include appropriate hardware and software components for capturing and processing these various input types, including, for example, microphones, cameras, text input devices, network interfaces for receiving electronic messages, and associated processing modules.

The deception detection engine 120 includes at least one processor that executes linguistic pattern analysis algorithms specifically designed to identify deception indicators in statements. Unlike known general-purpose natural language processing systems or content moderation systems, in the exemplary embodiment, the deception detection engine 120 implements specialized algorithms that analyze linguistic features empirically correlated with deceptive communication. More specifically, in the exemplary embodiment, the deception detection engine 120 analyzes multiple categories of linguistic patterns that research has shown to be associated with deception. For example, in the exemplary embodiment, the deception detection engine analyzes pronoun usage patterns and temporal specificity.

Deceptive statements often include a reduced use of first-person pronouns (I, me, my) as speakers “psychologically distance themselves” from false statements. The deception detection engine 120 calculates first-person pronoun frequency and compares it to baseline patterns for the determined context. Significant deviations from expected pronoun usage patterns generate deception indicators. In addition, truthful statements typically include specific temporal references (e.g., “at 3:15 PM” or “on Tuesday morning”), while deceptive statements often use vague temporal qualifiers (e.g., “around that time” or “sometime in the afternoon”). The deception detection engine 120 analyzes temporal references for specificity and flags vague temporal language as potential deception indicators.

It should be noted that the linguistic patterns described herein are based on empirical research in deception detection and represent statistical tendencies observed across populations. Individual variations exist, and the presence or absence of any single linguistic pattern is not determinative of deception. The deception detection engine 120 analyzes multiple patterns in combination and generates probabilistic assessments rather than binary determinations. The system's accuracy depends on the quality and representativeness of the training data, the appropriateness of the selected field-specific model, and the skill with which the AI avatar module 130 conducts follow-up questioning.

In addition, in the exemplary embodiment, the deception detection engine 120 also analyzes sensory detail, narrative structure, and emotional language congruence. Truthful recollections of experienced events typically include sensory details (what was seen, heard, smelled, felt), while fabricated accounts often lack such details. The deception detection engine 120 analyzes statements for presence and richness of sensory descriptions, generating deception indicators when sensory detail is absent or superficial. Moreover, truthful narratives typically follow a logical chronological structure with appropriate transitions, while deceptive narratives may exhibit structural inconsistencies, temporal jumps, or logical gaps. The deception detection engine 120 analyzes narrative coherence and flags structural anomalies as deception indicators. Furthermore, the emotional language used in a statement should be congruent with the facts being described. For example, describing a traumatic event with emotionally flat language, or describing a mundane event with excessive emotional language, may indicate deception. The deception detection engine 120 analyzes emotional language intensity and congruence with stated facts.

Moreover, in the exemplary embodiment, the deception detection engine 120 also analyzes verb tense consistency, specificity and detail level, and negative language. Deceptive statements sometimes exhibit unexpected verb tense shifts as speakers move between truthful and fabricated portions of their narrative. The deception detection engine 120 tracks verb tense usage and flags inconsistent tense patterns. Truthful statements typically maintain consistent levels of detail throughout, while deceptive statements may show uneven detail distribution, with excessive detail in truthful portions and vague generalities in fabricated portions. The deception detection engine 120 analyzes detail level consistency across the statement. Deceptive denials often use negative constructions (e.g., “I did not take the money”) rather than positive assertions (e.g., “I left the money where it was”). The deception detection engine 120 analyzes the ratio of negative to positive language constructions.

These linguistic pattern analyses are performed using a combination of rule-based algorithms, statistical models, and machine learning classifiers trained on deception-labeled datasets. The deception detection engine 120 generates a deception indicator profile for each analyzed statement, identifying which specific patterns suggest potential deception and with what confidence level.

Referring to FIG. 3, the deception detection engine 120 includes multiple analysis components that work in concert to identify deception indicators. In the exemplary embodiment, these components include a pronoun analysis module 122, a temporal analysis module 124, a sensory detail analysis module 126, a narrative structure analysis module 128, and an emotional congruence analysis module 129. Each module applies specialized algorithms to analyze its respective linguistic pattern category, generating confidence scores for detected deception indicators. The outputs from all of the modules are integrated by a deception indicator aggregation module (not shown) to generate the comprehensive deception indicator profile described above.

Referring to FIG. 8, an exemplary linguistic pattern analysis workflow illustrates how the deception detection engine 120 processes a statement to identify deception indicators. The workflow begins with statement ingestion and preprocessing (tokenization, part-of-speech tagging, dependency parsing). The preprocessed statement is then analyzed in parallel by multiple pattern analysis modules, each examining a specific linguistic feature. The results from each module are aggregated, weighted according to the field-specific model, and combined to generate an overall deception indicator profile with associated confidence scores for each identified indicator.

In some embodiments, the machine learning classifiers trained on deception-labeled datasets may include supervised learning models such as support vector machines (SVMs), random forests, gradient boosting machines, or deep neural networks. The training datasets may include thousands or millions of labeled statements, where each statement is annotated with ground-truth deception labels (deceptive/truthful) and, optionally, specific deception indicator labels (temporal vagueness, pronoun distancing, etc.). The models are trained to learn the complex, non-linear relationships between linguistic features and deception, achieving classification accuracy that exceeds rule-based approaches. In preferred embodiments, ensemble methods are employed, combining multiple classifiers to improve robustness and accuracy. The models may be periodically retrained or fine-tuned using feedback from system operators (as described in [0140]) to adapt to evolving deception patterns and improve performance over time.

The training process for the machine learning models may include collecting a training dataset of statements labeled with ground-truth deception indicators, preprocessing the statements to extract linguistic features, training the models using supervised learning techniques with the labeled data, validating the models on a held-out validation dataset, and iteratively refining the models based on validation performance. The training dataset may include statements from multiple fields and contexts to enable the models to learn field-specific patterns. In some embodiments, transfer learning techniques may be employed, wherein a model pre-trained on a large general corpus is fine-tuned on field-specific deception detection data. The training process may also incorporate active learning, wherein the system identifies statements for which it has low confidence and requests human annotation to improve the training dataset iteratively.

It is important to note how the deception detection engine 120 differs fundamentally from known systems that analyze communication content. At least some known systems analyze communications to detect inappropriate tone, offensive language, or policy violations. These systems typically use sentiment analysis, keyword matching, or general-purpose natural language processing to identify content that violates communication policies or social norms.

In contrast, the deception detection engine 120 does not focus on whether content is appropriate, offensive, or policy-compliant. Instead, it analyzes linguistic patterns specifically correlated with deceptive intent. A statement can be perfectly appropriate and policy-compliant yet still be deceptive. Conversely, a statement can be inappropriate or offensive yet still be truthful. The deception detection engine 120 operates on an entirely different dimension of analysis—truthfulness versus deception—rather than appropriateness versus inappropriateness.

For example, consider the statement: “I was at the store around 3 PM.” A prior art content moderation system would analyze this statement for inappropriate language, offensive terms, or policy violations and would find none. The statement would pass content analysis as acceptable.

The deception detection engine 120, however, analyzes this statement for deception indicators. It identifies the temporal vagueness marker “around” rather than at a specific time. It notes the lack of sensory detail (which store? what was purchased? who else was present?). It may note the absence of first-person possessive pronouns that would indicate personal connection to the activity. These linguistic patterns generate deception indicators that trigger follow-up questioning, regardless of whether the content is appropriate or policy compliant.

The deception detection engine 120 also differs fundamentally from prior art fact-checking systems that verify statements against external databases or reference sources. At least some known prior art systems receive statements made during phone calls or in written communications and verify the factual accuracy of those statements by comparing them to third-party databases, online information sources, or comparative statements from other individuals.

These fact-checking systems determine whether a statement matches known factual information. For example, if a caller states, “I am calling from ABC Company,” a fact-checking system might verify whether the caller's phone number is associated with ABC Company in a business directory database. If the verification succeeds, the system concludes that the statement is accurate. If the verification fails, the system concludes that the statement is inaccurate.

In contrast, in the exemplary embodiment, the deception detection engine 120 operates on an entirely different principle. The system 100 does not verify factual accuracy against external sources. Rather, it analyzes the linguistic structure and patterns within the statement itself to identify indicators of deceptive intent. This distinction is critical because:
First, factual accuracy and truthfulness are related but distinct concepts. A person can make factually accurate statements while still being deceptive through omission, misdirection, or manipulative framing. For example, a person might accurately state “I was at the office on Tuesday” while deceptively omitting that they left early and were at a competitor's office in the afternoon. The factual statement is accurate but deceptive in context. Prior art fact-checking systems would verify the statement as accurate and miss the deception. The deception detection engine 120 would identify linguistic patterns suggesting omission or incompleteness and generate follow-up questions to probe the full context.
Second, a person may make factually inaccurate statements due to honest mistake, faulty memory, or misunderstanding rather than deceptive intent. For example, a person might incorrectly state “I was at the store on Tuesday” when they were actually there on Wednesday, due to confusion about dates. The factual statement is inaccurate but not deceptive. Prior art fact-checking systems would flag this as false. The deception detection engine 120 would analyze the linguistic patterns and, finding no deception intent (such as vagueness, evasiveness, and/or lack of an appropriate amount of detail), would not generate strong deception indicators.
Third, fact-checking systems require external databases or reference sources to operate. If such sources are unavailable, incomplete, or unreliable, fact-checking cannot be performed. The deception detection engine 120 operates independently of external sources, analyzing the statement itself. This enables deception detection in contexts where external verification is impossible, impractical, or when the facts are not objectively verifiable.

In the exemplary embodiment, the AI avatar module 130 generates and presents follow-up questions based on the deception indicators identified by the deception detection engine 120. The AI avatar module 130 creates questions specifically designed to probe the identified deception indicators, elicit additional information, and resolve ambiguities. The questions are contextually relevant, naturally phrased, and targeted to the specific deception indicators detected.

For example, if the deception detection engine 120 identifies temporal vagueness in a statement, the AI avatar module 130 generates questions requesting specific temporal information. If the deception detection engine 120 identifies lack of sensory detail, the AI avatar module 130 generates questions requesting specific sensory descriptions. If the deception detection engine 120 identifies narrative inconsistencies, the AI avatar module 130 generates questions probing the inconsistent elements.

The AI avatar module 130 may present questions through various modalities depending on the interaction context. In text-based interactions (such as email or SMS), questions are presented as text. In voice-based interactions (such as phone calls), questions are presented as synthesized speech. In video-based interactions, questions may be presented by an animated avatar with synthesized speech.

The AI avatar module 130 adapts its questioning style to the determined field and context. For example, in a formal legal proceeding context, questions may be phrased formally and directly. In a customer service context, questions may be phrased more conversationally and politely. The field-specific models (described below) include question style guidelines that the AI avatar module 130 applies.

In the exemplary embodiment, the AI avatar module 130 includes a question generation engine 132, a context manager 134, and a presentation interface 136. The question generation engine 132 receives the deception indicator profile from the deception detection engine 120 and generates appropriate follow-up questions. The context manager 134 maintains awareness of the conversation history, previously asked questions, received responses, and the evolving deception indicator profile. The presentation interface 136 formats and presents the generated questions through the appropriate modality (text, speech, video avatar).

The question generation engine 132 may utilize various techniques to generate questions. In some embodiments, the question generation engine 132 uses template-based generation, wherein predefined question templates are populated with specific information from the statement and deception indicators. For example, a template for probing temporal vagueness might be: “You mentioned [vague temporal reference]. Can you provide a more specific time?” This template would be populated with the actual vague temporal reference from the statement.

In other embodiments, the question generation engine 132 uses large language models (LLMs) to generate questions. The question generation engine 132 provides the LLM with the statement, the identified deception indicators, the field-specific context, and instructions to generate appropriate follow-up questions. The LLM generates natural language questions that probe the deception indicators. This approach enables more flexible and natural question generation compared to template-based approaches.

In preferred embodiments, the question generation engine 132 combines both approaches, using templates for common deception indicator types and LLMs for more complex or unusual situations. This hybrid approach balances the reliability of template-based generation with the flexibility of LLM-based generation.

The question generation engine 132 prioritizes which deception indicators to probe based on their severity, confidence level, and relevance to the determined field. For example, in an insurance fraud context, deception indicators related to the circumstances of the claimed incident would be prioritized over deception indicators related to peripheral details. The prioritization ensures that the most important deception indicators are addressed first, and that questioning time is used efficiently.

The context manager 134 maintains a comprehensive record of the interaction, including the original statement, all follow-up questions asked, all responses received, and the evolving deception indicator profile. This context enables the AI avatar module 130 to avoid asking redundant questions, to build upon previous responses, and to adapt its questioning strategy based on how the subject responds.

For example, if a subject provides vague responses to initial follow-up questions, the context manager 134 notes this pattern and the AI avatar module 130 generates more specific, direct questions in subsequent cycles. If a subject provides detailed, specific responses that resolve deception indicators, the context manager 134 notes this and the AI avatar module 130 focuses on remaining unresolved indicators.

The presentation interface 136 formats questions appropriately for the presentation modality. For text-based interactions, the presentation interface 136 formats questions as clear, readable text. For voice-based interactions, the presentation interface 136 converts questions to speech using text-to-speech synthesis, with appropriate prosody and pacing. For video-based interactions, the presentation interface 136 may animate an avatar to deliver questions with appropriate facial expressions and gestures.

The dynamic generation of contextually-relevant questions is performed in real-time, meaning that questions are generated and presented to the subject during an ongoing interaction session without requiring batch processing or offline analysis. The question generation engine 132 receives the deception indicator profile immediately upon completion of statement analysis by the deception detection engine 120, and generates appropriate follow-up questions within a response time suitable for natural conversational flow (typically within 1-3 seconds for text-based interactions, or within 0.5-1 second for voice-based interactions). The contextual relevance of generated questions is ensured by the context manager 134, which maintains awareness of the conversation history, previously asked questions, received responses, and the evolving deception indicator profile. This real-time, context-aware question generation enables the system to adapt its questioning strategy dynamically based on the subject's responses, distinguishing it from systems that follow predetermined question scripts or require human intervention to formulate follow-up questions.

The AI avatar module 130 distinguishes the present invention from known systems that provide static analysis or predetermined questioning. Known systems may analyze a statement and generate a report, but they do not conduct interactive questioning. Other known systems may conduct interviews using predetermined question scripts, but they do not adapt their questioning based on detected deception indicators. The AI avatar module 130 combines real-time deception detection with adaptive, dynamic questioning, creating a progressive refinement process that is not present in known systems.

Referring to FIG. 7, the question generation engine 132 includes multiple components that collaborate to generate contextually appropriate follow-up questions. In the exemplary embodiment, these components include a deception indicator prioritization module 133, a question template library 135, a large language model interface 137, and a question refinement module 139. The deception indicator prioritization module 133 ranks detected indicators based on severity, confidence, and field-specific relevance. The question template library 135 stores field-specific question templates for common deception indicator types. The large language model interface 137 communicates with open-source or proprietary LLMs to generate natural language questions. The question refinement module 139 ensures questions are contextually appropriate, grammatically correct, and aligned with the determined field and interaction style.

The presentation interface 136 presents the generated questions to the subject through appropriate modalities. In an embodiment where the subject is interacting via text, the questions are presented as text. In an embodiment where the subject is interacting via voice, the questions are converted to speech using text-to-speech technology and presented audibly. In an embodiment using video, the AI avatar may be presented as a visual avatar with synthesized speech. The presentation interface 136 may be configured to present questions in a manner appropriate to the determined context and field, using professional language for formal contexts and more casual language for informal contexts.

In the exemplary embodiment, the response analysis module 140 analyzes responses to follow-up questions to identify additional deception indicators. The response analysis module 140 applies the same linguistic pattern analysis algorithms used by the deception detection engine 120, but with additional analysis specific to responses.

Specifically, the response analysis module 140 analyzes whether responses are consistent with the original statement and with each other. Inconsistencies between the original statement and responses, or between different responses, may indicate deception. The response analysis module 140 flags such inconsistencies as deception indicators.

The response analysis module 140 also analyzes whether responses provide the requested specific details, or whether they remain vague despite direct questioning. Continued vagueness in response to specific questions is a strong deception indicator, as it suggests the subject is unable or unwilling to provide details that would be available if the statement were truthful.

The response analysis module 140 also analyzes response latency-how quickly the subject responds to questions. Response latency may be measured in text-based interactions by analyzing typing patterns, or in voice-based interactions by analyzing speech timing. Unusually long response latencies for simple factual questions may indicate fabrication, as the subject takes time to construct a plausible response. Conversely, unusually quick responses to complex questions may indicate rehearsed or scripted responses.

Specifically, in the exemplary embodiment, the response analysis module 140 analyzes: consistency—are the responses consistent with the original statement and with each other? Inconsistencies may indicate deception. The response analysis module 140 also analyzes the detail level provided by the subject to determine if the responses provide the requested specific details, or if the details remain vague. Continued vagueness despite direct questioning may indicate deception. With respect to the timing of responses provided by the subject, the response analysis module 140 also analyzes the response latency to determine how quickly the subject responds to questions. Response latency may be measured in text-based interactions by analyzing typing patterns, or in voice-based interactions by analyzing speech timing. Unusually long response latencies for simple factual questions may indicate fabrication.

In the exemplary embodiment, the response analysis module 140 also analyzes linguistic patterns to determine whether the responses exhibit the same deception indicators as the original statement, or whether they show different patterns. Changes in linguistic patterns across responses may indicate areas of truthfulness versus deception. Moreover, the response analysis module 140 also analyzes the evasiveness of the subject to determine whether the subject directly answer the questions, or whether the subject attempted to evade, deflect, or provide tangential information. Evasiveness may indicate deception. Lastly, the response analysis module 140 also analyzes over specification to determine whether the responses provide excessive, and/or unnecessary detail? While lack of detail can indicate deception, excessive detail (particularly about peripheral matters) can also indicate fabrication, as deceptive individuals sometimes over-compensate.

The response analysis module 140 generates an updated deception indicator profile that incorporates both the original statement analysis and the response analysis, thus providing a more comprehensive assessment than could be obtained from the original statement alone.

In the exemplary embodiment, the iterative questioning controller 150 manages multiple cycles of questioning and analysis and thus implements the progressive refinement process that distinguishes the present invention from known static analysis systems. The iterative questioning controller 150 determines when additional questioning is needed, what areas require further probing, and when sufficient information has been gathered to generate a final deception assessment. For example, in the exemplary embodiment, as best seen in FIG. 4, the iterative questioning process initially analyzes 410 the current statement or response to identify deception indicators, and then determines 420 whether additional questions is needed. The determination 420, in the exemplary embodiment, is based on: (a) a confidence level of current deception assessment, (b) a number of unresolved deception indicators, (c) a consistency of indicators across multiple responses, (d) a predetermined maximum number of interaction cycles, and/or (e) a subject termination of interaction.

If additional questioning is needed 430, follow-up questions targeting highest-priority deception indicators are generated and presented 440 to the subject. The system 100 then receives and analyzes 450 responses. The deception assessment is updated 460 based on response analysis and the system 100 determines 420 whether additional questioning 470 based on the response analysis, or whether questioning is complete 480 and a final deception assessment is generated by the system 100.

This iterative process enables progressive refinement of the deception assessment. Initial deception indicators may be resolved through follow-up questioning, reducing the deception assessment. Alternatively, responses to follow-up questions may reveal additional deception indicators, increasing the deception assessment. The iterative process continues until a stable, confident assessment is reached or predetermined stopping criteria are met.

The iterative questioning controller 150 prioritizes which deception indicators to probe based on their severity, confidence level, and relevance to the determined context. For example, in an insurance fraud context, deception indicators related to the circumstances of the claimed incident would be prioritized over deception indicators related to peripheral details.

The prioritization of deception indicators by the iterative questioning controller 150 is performed using a multi-factor scoring algorithm. In the exemplary embodiment, each deception indicator is assigned a priority score based on: (1) the confidence level of the indicator (higher confidence indicators receive higher priority); (2) the severity weight assigned to that indicator type in the field-specific model (indicators that are strongly correlated with deception in the determined field receive higher priority); (3) the criticality of the information to which the indicator relates (indicators related to central facts of the investigation receive higher priority than indicators related to peripheral details); and (4) the resolvability of the indicator through follow-up questioning (indicators that can be effectively probed through targeted questions receive higher priority than indicators that are difficult to resolve). The priority scores are calculated for all unresolved indicators after each interaction cycle, and the highest-priority indicators are selected for probing in the next cycle. This dynamic prioritization ensures that the iterative questioning process efficiently focuses on the most important and actionable deception indicators.

In the exemplary embodiment, the field-specific model database 160 stores specialized deception detection models for multiple fields and contexts. Research has shown that deception manifests differently across domains, and linguistic patterns that strongly indicate deception in one context may be less significant in another. For example, in insurance claim contexts, vague descriptions of accident circumstances and passive voice constructions are strong deception indicators, as claimants attempting to commit fraud often avoid specific details that could be verified or contradicted. In contrast, in witness testimony contexts, some vagueness may be expected for events that occurred in the past, and the absence of certain sensory details may reflect normal memory limitations rather than deception.

In the exemplary embodiment, the field-specific model database 160 includes specialized models for contexts may include, but are not limited to only including, insurance claims (auto, property, health, life), witness testimony (criminal, civil), employment screening and interviews, financial fraud investigations, relationship contexts (dating, marriage counseling), legal proceedings (depositions, interrogations), security clearance interviews, medical history verification, academic integrity assessment, customer service interactions, investigative journalism, background checks, asylum and immigration claims, child custody evaluations, elder abuse investigations, and/or workplace harassment claims. Other specialized models for contexts may include, but are not limited to only including, product liability claims, intellectual property disputes, contract negotiations, merger and acquisition due diligence, regulatory compliance interviews, and/or forensic accounting investigations, for example.

In the exemplary embodiment, each field-specific model may include a weighted importance of different deception indicators for that field, a baseline linguistic pattern(s) for truthful statements in that field, field-specific question templates for probing deception indicators, threshold values for deception assessment in that field, common deception patterns observed in that field

The system 100, in the exemplary embodiment, includes a field determination module (not shown) that analyzes the initial statement and interaction context to determine which field-specific model to apply. In some embodiments, the field-specific module may be explicitly specified by the system operator. In other embodiments, the field-specific module is automatically determined through analysis of statement content, keywords, and context.

Referring to FIG. 6, the field determination module analyzes multiple factors to select the appropriate field-specific model from the field-specific model database 160. These factors may include keyword analysis (identifying domain-specific terminology), contextual analysis (determining the setting or purpose of the interaction), metadata analysis (examining source information such as email headers or form fields), and explicit operator input. The field determination module applies a classification algorithm, which may include rule-based logic, machine learning classifiers, or a combination thereof, to determine the most appropriate field-specific model with an associated confidence score.

Referring to FIG. 5, in the exemplary embodiment, the system 100 processes multimodal inputs, thus integrating analysis across text, speech, and video modalities to provide comprehensive deception detection. The multimodal processing architecture may include, but is not limited to only including, a text analysis module 510, a speech analysis module 520, a video analysis module 530, and/or a multimodal integration module 540. The text analysis module 510 performs the linguistic pattern analysis described above on textual content, whether that content is directly entered as text, transcribed from speech, or extracted from email or SMS messages.

In the exemplary embodiment, the speech analysis module 520 analyzes acoustic features of speech that may indicate deception. More specifically, in the exemplary embodiment, the speech analysis module 520 may analyze, but is not limited to only analyzing, voice stress patterns, speech rate variations (deceptive speech often exhibits increased speech rate or unusual pauses), vocal pitch changes (deceptive speech may exhibit higher pitch due to stress), speech disfluencies (increased “um,” “uh,” false starts, or corrections may indicate fabrication), and/or voice quality changes (tension, breathiness).

Similarly, in the exemplary embodiment, the video analysis module 530 analyzes visual features that may indicate deception, including, but not limited to only including, micro-expressions (brief, involuntary facial expressions that may reveal concealed emotions), eye movement patterns (gaze aversion, increased blinking, or unusual eye movements may indicate deception), body language indicators (fidgeting, self-touching, postural shifts), and/or facial expression congruence with verbal content (a determination of whether the facial expressions match the emotional content of statements.)

In the exemplary embodiment, the multimodal integration module 540 combines indicators from all modalities according to the field-specific model to generate an overall deception assessment. Different modalities may be weighted differently depending on the context and the reliability of each modality's indicators. It should be noted that the multimodal processing of the present invention differs from that of known systems that process multiple input types. For example, at least some known systems may accept text, speech, and video inputs for purposes of general content understanding, interaction intent detection, or accessibility. Such systems process multiple modalities to understand what the user is communicating or to determine if the user intends to interact with the system.

The weighting of different modalities is determined by the field-specific model and may be adjusted based on the reliability and availability of each modality's indicators. For example, in a field-specific model for insurance claims conducted via phone, speech analysis indicators may be weighted more heavily than video analysis indicators (which may be unavailable). The weights may be learned through machine learning on field-specific training data, or may be manually configured by domain experts. In one embodiment, the multimodal integration module 540 applies a weighted linear combination of normalized deception scores from each modality: Overall\_Score=w\_text×Text\_Score+w\_speech×Speech\_Score+w\_video×Video\_Score, where w\_text, w\_speech, and w\_video are the field-specific weights that sum to 1.0. In alternative embodiments, more sophisticated fusion techniques such as neural network-based fusion or Bayesian fusion may be employed.

In contrast, in the exemplary embodiment, the multimodal integration module 540 specifically integrates analysis across modalities to detect deception-specific indicators. The speech analysis module 520 does not perform general speech recognition, but rather, the speech analysis module analyzes acoustic features correlated with deception. Similarly, the video analysis module 530 does not perform general image understanding, but rather it detects visual indicators correlated with deception. Likewise, the multimodal integration module 540 does not combine modalities for general content understanding, but rather it combines deception-specific indicators across modalities to generate a deception assessment.

In the exemplary embodiment, the output interface 170 provides deception assessment results in formats appropriate to the application context. In some embodiments, the output interface 170 may provide real-time feedback. For example, during live interactions, the output interface 170 may provide immediate feedback to system operators, such as highlighting statements with high deception indicators, displaying deception scores, and/or alerting operators to areas requiring additional probing.

In the exemplary embodiment, after interaction completion, the output interface 170 may generate comprehensive reports including for example, the original statement, all follow-up questions and responses, identified deception indicators with confidence levels, field-specific analysis, multimodal indicator integration, and/or a final deception assessment with supporting evidence. The output interface 170 may also in addition or in the alternative generate visual representations of deception indicators, such as highlighting text portions with different colors based on deception indicator strength, displaying timeline visualizations showing narrative structure, or presenting graphs of deception scores across interaction cycles.

For integration with other systems, the output interface 170 may provide structured data outputs via application programming interfaces (APIs), enabling automated processing of deception assessments. Moreover, the output interface 170 may generate complete audit trails of the analysis process, including all intermediate assessments, algorithm decisions, and confidence levels, supporting transparency and accountability in deception detection applications.

In some alternative embodiments involving militarized humanoid integration, the deception detection system 100 may be implemented as a cognitive module within a militarized humanoid system (not shown). The militarized humanoid system may include a humanoid robotic platform (not shown) with sensors, such as, but not limited to only including, cameras, microphones, environmental sensors, actuators that enable movement and manipulation, a central processing unit for executing the deception detection system 100 as a cognitive module, communication interfaces for mesh networking and command communication, and power systems.

In such an alternative embodiment, the cognitive module implementing the deception detection system 100 may interface with other cognitive modules within the militarized humanoid, including navigation modules, threat assessment modules, mission planning modules, and/or communication modules. The deception detection system 100 may receive statements from subjects via the humanoid's sensors, process the statements to identify deception indicators, generate and present follow-up questions via the humanoid's speech synthesis and display systems, and provide deception assessments as actionable intelligence to warfighters via the communication interfaces. In operational scenarios, the militarized humanoid may approach foreign nationals, initiate conversations in the foreign national's language (using integrated translation systems), conduct deception detection during the conversation, and transmit intelligence reports to command personnel or other warfighters. The humanoid may operate autonomously or under remote human supervision depending on the operational mode configuration.

In another alternative embodiment, the deception detection system 100 may be distributed in edge deployment embodiments, for example, across multiple edge devices (not shown) connected via a mesh network. Each edge device may include local processing capabilities, local storage, and mesh networking interfaces. The edge devices may communicate via wireless mesh networking protocols (such as IEEE 802.11s, Zigbee, or military-specific mesh protocols) that enable multi-hop communication without centralized infrastructure. Each edge device may execute a complete instance of the deception detection system 100, enabling independent operation. Alternatively, system components may be distributed across edge devices, with some devices performing statement analysis, others performing question generation, and others performing response analysis, with results communicated via the mesh network.

In such an alternative embodiment, the edge deployment architecture may include a local coordination node that synchronizes deception detection models across edge devices, aggregates deception assessments from multiple devices, and manages mesh network topology. The coordination node may be implemented on a dedicated device or may be a role assumed by one of the edge devices. When internet connectivity is available, the edge deployment may synchronize with cloud-based systems to receive model updates, upload operational data for analysis, or access additional computing resources. However, the edge deployment maintains full operational capability when disconnected from cloud systems.

Moreover, in such an embodiment, the deception detection system 100 may include an operational mode controller that manages selection and transition between human-assisted, fully autonomous, and hybrid operational modes. The operational mode controller may receive mode selection inputs from system operators, monitor system performance metrics, analyze operational conditions, and determine appropriate operational modes. In some embodiments, the operational mode controller applies rule-based logic to determine mode transitions. For example, rules may specify that autonomous mode is used for routine interactions but human-assisted mode is required for interactions involving high-value targets, interactions where deception scores exceed defined thresholds, or interactions in sensitive political contexts.

In other alternative embodiments, the operational mode controller applies machine learning models trained to predict appropriate operational modes based on contextual factors such as subject characteristics, interaction complexity, available human operator resources, mission criticality, and historical performance data. The operational mode controller may implement gradual transitions between modes. For example, when transitioning from autonomous to human-assisted mode, the system 100 may continue autonomous operation while alerting human operators and providing them with context, then transfer control to human operators when they acknowledge readiness. When transitioning from human-assisted to autonomous mode, the system 100 may initially operate autonomously with human oversight, then reduce human involvement as confidence increases.

Referring to FIG. 2, in the exemplary embodiment, a method 200 for deception detection may include, but is not limited to only including, receiving 210 a statement from a subject via at least one input modality selected from text input, speech-to-text conversion, video analysis, email, and/or SMS messaging. The statement may be received in response to an initial question posed by the system 100, or may be a spontaneous statement provided by the subject.

The statement is analyzed 220 using deception detection algorithms to identify at least one deception indicators. This analysis 220 includes applying linguistic pattern analysis algorithms that examine pronoun usage patterns, temporal specificity, sensory detail, narrative structure, emotional language congruence, verb tense consistency, detail level consistency, and negative language patterns. The analysis 220 generates a deception indicator profile identifying which specific patterns suggest potential deception and with what confidence level.

The field or context of the interaction is then determined/identified 230. Such a determination 230 may be performed through analysis of statement content, keywords, and context, or may be explicitly specified by a system operator. Based on the determined field, the appropriate field-specific deception detection model is then identified from the field-specific model database 160.

One or more follow-up questions are then generated 240 based on the identified deception indicators. The question generation is performed by the AI avatar module 130, which creates questions specifically designed to probe the identified deception indicators. The questions are contextually relevant, naturally phrased, and targeted to elicit information that will help resolve or confirm the deception indicators.

The follow-up questions are then presented 250 to the subject in real-time through the appropriate presentation modality (text, speech, video avatar). One or more responses to the follow-up questions are received 260 from the subject. The responses are analyzed 270 to identify additional deception indicators. This analysis 270 examines consistency with the original statement, detail level, response latency, linguistic patterns, evasiveness, and over-specification, for example. The analysis 270 generates an updated deception indicator profile incorporating both the original statement analysis and the response analysis.

A determination 280 is then made as to whether additional questioning is needed. This determination 280 is based on the confidence level of the current deception assessment, the number of unresolved deception indicators, the consistency of indicators across multiple responses, predetermined maximum number of interaction cycles, or subject termination of the interaction. If additional questioning is determined 280 as being needed, the process generates 240 additional follow-up questions targeting the highest-priority remaining deception indicators. This creates an iterative questioning process that progressively refines the deception assessment.

When questioning is complete (either because sufficient confidence has been reached, a pre-defined number of maximum interaction cycles have been completed, and/or the subject has terminated the interaction), a final deception assessment is generated 290. The final assessment includes the overall deception score, identified deception indicators with confidence levels, supporting evidence from the statement and responses, field-specific analysis, and any multimodal indicators if applicable, for example.

### Example #1

The following detailed example illustrates the operation of the system 100 in an exemplary insurance claim context.

A claimant states: “I was driving home from work last Tuesday when someone hit my car. It was really bad. My neck has been hurting ever since.” Initially, the deception detection engine 120 analyzes the claimant's statement and identifies several deception indicators, including but not limited to, temporal vagueness: “last Tuesday”—lacks specific time, passive construction: “someone hit my car”—uses passive voice, potentially distancing from responsibility, vague spatial reference: no description of where the accident occurred, and a vague severity description: “really bad”—lacks specific detail. In addition, in the exemplary embodiment, the deception detection engine 120 also identifies the lack of sensory details: no description of what was seen, heard, or felt during the accident, the minimal narrative structure: statement jumps from accident to injury without describing the accident itself, and the use of emotional language: “really bad” and “hurting”—lacks specific sensory descriptions of pain.

The system 100 determines this is an insurance claim context based on keywords and context. The field-specific model for auto insurance claims is selected from the field-specific model database 160. Based on the deception indicators and the insurance claim field model, the AI avatar generates 240 the following exemplary follow-up questions:
1. “What time did the accident occur on Tuesday?”
2. “Where exactly were you when the accident happened?”
3. “Can you describe what you saw immediately before the impact?”
4. “What direction was the other vehicle traveling?”
5. “Describe the impact-what did you hear and feel?”
6. “What damage did you observe to your vehicle immediately after the accident?”

The AI avatar 130 presents 250 these questions to the claimant via the interaction interface. In the example, the claimant responds 260:
1. “It was around 5:30 or 6:00, I'm not exactly sure.”
2. “I was on Main Street, heading toward the highway.”
3. “I didn't really see it coming. It happened so fast.”
4. “I think they were coming from the left, from a side street.”
5. “There was a loud bang and I felt a jolt. It was scary.”
6. “The whole side of my car was smashed in. It was terrible.”

The response analysis module 140 analyzes 270 these responses. In the analysis 270 of the responses, the response analysis module identifies continued deception indicators:
Response 1: Continued temporal vagueness despite direct question (“around 5:30 or 6:00”)
Response 2: Provides some spatial detail but still vague (which part of Main Street? which direction?)
Response 3: Evasive response, doesn't provide visual details requested (“didn't really see it”)
Response 4: Uncertain language (“I think”) about critical fact
Response 5: Generic sensory descriptions (“loud bang,” “jolt”) that could apply to any accident
Response 6: Vague damage description (“whole side,” “smashed in”) without specific details

More specifically, the response analysis module 140 identifies continued deception indicators: temporal vagueness persists, spatial details remain incomplete, visual details are avoided, uncertainty about critical facts, generic rather than specific sensory descriptions, and vague damage descriptions. In response, the iterative questioning controller 150 determines that additional questioning is needed because: (a) deception indicators persist in responses, (b) critical details remain unspecified, (c) confidence in deception assessment is not yet sufficient. The AI avatar then generates 240 more specific follow-up questions targeting the persistent deception indicators:
1. “You mentioned you were on Main Street heading toward the highway. Were you north or south of the intersection with Oak Street?”
2. “Even though it happened fast, what is the last thing you remember seeing before the impact?”
3. “You said the other vehicle came from the left. Was it a car, truck, or SUV?”
4. “Can you describe specifically which parts of your vehicle were damaged?”
5. “Did you see the other driver after the accident?”
6. “What did you do immediately after the impact?”

The additional questions are presented 250 and responses are received 260. If the claimant's responses continue to show vagueness, evasiveness, and lack of specific detail, the response analysis module 140 notes that despite multiple rounds of specific questioning, the claimant continues to provide vague, generic responses and avoids providing specific visual details.

The iterative questioning controller 150 determines 280 that sufficient information has been gathered. The pattern of persistent deception indicators across multiple questioning rounds, combined with the field-specific model for insurance claims (which weights vagueness about accident circumstances heavily), provides sufficient confidence for a final assessment.

In Example #1, the system 100 generates 290 a final deception assessment: a deception score of 7.8 out of 10 (high likelihood of deception). The primary deception indicators include persistent temporal vagueness despite direct questioning, avoidance of specific visual details about the accident, generic sensory descriptions that lack specificity, vague damage descriptions, uncertainty about critical facts (direction of other vehicle), and evasive responses to direct questions. In the field-specific analysis, tailored to the auto insurance claim context, these patterns are strongly associated with fraudulent claims wherein the claimant is fabricating or exaggerating the accident circumstances. The system 100 then recommends a high-priority investigation and suggests obtaining police report, surveillance footage if available, a vehicle damage assessment by independent adjuster, and a medical records review.

This example illustrates how the system 100 progressively refines its deception assessment through iterative questioning, how it applies field-specific models to weight indicators appropriately, and how it generates actionable outputs for decision-makers.

The system 100 may be implemented on various computing platforms depending on the application requirements. For high-volume applications such as insurance claim processing or customer service monitoring, the system 100 may be implemented on server infrastructure with distributed processing capabilities. For field applications such as law enforcement interviews or security screenings, the system 100 may be implemented on portable computing devices such as tablets or laptops.

In one alternative embodiment, the system 100 is implemented in a wearable display device. In such an embodiment, the system 100 captures spoken communication from a subject through one or more onboard sensors and derives linguistic content from the captured communication. The system 100 in such an embodiment, analyzes the linguistic content for indicators of deception, and provides real-time feedback to the wearer via the wearable device's display.

The deception detection algorithms may be implemented using a combination of programming languages and frameworks suitable for natural language processing and machine learning, such as Python with libraries including NLTK, spaCy, TensorFlow, or PyTorch. The AI avatar module 130 may utilize large language models such as GPT-based models, BERT-based models, or other transformer architectures, either through API access to cloud-based models or through local deployment of open-source models.

The system 100 may include appropriate security measures to protect sensitive data processed during deception detection, including encryption of stored data, secure transmission protocols, access controls, and audit logging. In applications involving personal information, the system may be configured to comply with relevant privacy regulations such as GDPR, CCPA, or HIPAA. The system 100 may include user interfaces for system operators to configure field-specific models, adjust threshold values, review deception assessments, and provide feedback for system improvement. The system 100 may implement machine learning feedback loops where operator corrections to deception assessments are used to refine the deception detection algorithms over time.

The system 100 may be configured to operate in accordance with applicable privacy laws, ethical guidelines, and industry best practices for deception detection technologies. In some embodiments, the system 100 includes consent management functionality that ensures subjects are informed about the deception detection analysis and provide appropriate consent before analysis begins. The system 100 may implement data minimization principles, retaining only the data necessary for deception assessment and deleting or anonymizing data after a specified retention period. In applications where deception detection results may have significant consequences for subjects (such as employment decisions, insurance claim denials, or law enforcement actions), the system 100 may be configured to provide explainable AI outputs, wherein the specific linguistic patterns and deception indicators that contributed to the assessment are clearly identified and presented to human decision-makers. The system 100 may also implement fairness and bias mitigation techniques to ensure that deception detection does not disproportionately impact protected demographic groups. In some embodiments, the system 100 includes an appeals or review process whereby subjects can challenge deception assessments and request human review.

In the exemplary embodiment, the deception detection system 100 provides numerous distinctions over known systems, particularly with respect to communication content analysis systems, fact-checking systems, and conversational AI and sensor fusion systems. Each of these distinctions is described in more detail below.

With respect to communication content analysis systems, at least some known systems that analyze communication content focus on detecting policy violations, inappropriate tone, or offensive language rather than deceptive intent. Such systems analyze static, completed communications rather than conducting real-time interactive analysis. Moreover, such systems use general-purpose natural language processing without specialized deception-detection linguistic patterns, provide passive notifications rather than active interrogation through follow-up questioning, and lack field-specific deception indicators tailored to specialized domains.

In contrast, in the exemplary embodiment, the deception detection system 100 specifically targets deception detection through deception-specific linguistic patterns, conducts interactive iterative analysis with dynamic questioning, operates in real-time with adaptive questioning, and provides field-specific deception detection across specialized domains.

With respect to fact-checking systems, at least some known fact-checking systems determine whether statements match external reference sources, whereas the deception detection system 100 detects deception through linguistic analysis regardless of factual accuracy. Such known systems require external databases or comparative statements for verification, while the deception detection system 100 operates independently of external verification. Moreover, such known systems analyze what is said (content verification), while the deception detection system 100 analyzes how it is said (linguistic pattern analysis indicative of deception). Furthermore, such known systems do not generate adaptive follow-up questions to probe inconsistencies.

In contrast, in the exemplary embodiment, the deception detection system 100 distinguishes between factual accuracy and deceptive intent, operates independently through linguistic analysis, and conducts interactive probing to progressively refine deception assessment.

With respect to conversational AI and sensor fusion systems, at least some known systems using sensor fusion and AI for human-computer interaction determine whether a user intends to interact with a device (attention detection), not whether the user's statements are truthful. The sensor fusion in such systems analyzes gaze direction, proximity, and sound energy to determine interaction intent, whereas the deception detection system 100 analyzes linguistic patterns to determine truthfulness. Moreover, such known systems determine when to respond to user commands, whereas the deception detection system 100 assesses the veracity of user statements during an investigative or evaluative interaction.

In contrast, in the exemplary embodiment, the deception detection system 100 focuses on deception detection rather than interaction intent detection, analyzes linguistic patterns rather than attention indicators, and conducts active interrogation rather than passive response to commands.

The deception detection system 100 uniquely combines: (1) real-time deception detection through linguistic pattern analysis; (2) interactive AI avatar with dynamic, context-aware follow-up questioning; (3) iterative analysis that refines deception assessment across multiple interaction cycles; (4) multimodal input processing specifically for deception detection; (5) field-specific deception detection models across specialized domains; (6) integration of algorithms and open-source LLMs for question generation; and (7) immediate feedback and scoring during live interactions. No known system combines these elements to provide comprehensive, interactive, real-time deception detection across multiple communication modalities and specialized fields.

The deception detection system 100 provides numerous technical advantages over known systems. For example, by using linguistic patterns specifically correlated with deceptive intent rather than general content analysis or factual verification, the deception detection system 100 achieves higher accuracy for deception detection applications. Moreover, the iterative questioning process enables progressive refinement of deception assessments, resolving ambiguous indicators and increasing confidence through multiple interaction cycles.

The deception detection system 100 may be validated through empirical testing on benchmark datasets and real-world applications. In some embodiments, the system achieves deception detection accuracy (measured as the area under the receiver operating characteristic curve, or AUC-ROC) of 0.75 to 0.90 across various field-specific contexts, representing substantial improvement over baseline methods such as random guessing (AUC-ROC=0.50) or simple keyword-based detection. The iterative questioning process has been shown to improve deception detection accuracy by 10-25% compared to analysis of initial statements alone, demonstrating the value of the interactive approach. The system's performance may be continuously monitored and evaluated through comparison with ground-truth deception labels (when available) or through correlation with outcomes of independent investigations. Performance metrics may be tracked separately for each field-specific model to identify areas for improvement and guide model refinement efforts.

In addition, in the exemplary embodiment, the deception detection system 100 operates through linguistic analysis independent of external databases, enabling deception detection when verification sources are unavailable or when factually accurate statements are deceptively presented. Furthermore, specialized models for different fields provide superior accuracy by accounting for domain-specific variations in how deception manifests.

Moreover, in the exemplary embodiment, the deception detection system 100 provides immediate feedback during live interactions, enabling real-time decision-making in contexts such as interviews, customer service, or security screenings. The deception detection system 100 can also process statements from multiple subjects simultaneously, making it suitable for large-scale applications. In addition, integration of text, speech, and video analysis provides more comprehensive deception detection than single-modality systems. Furthermore, the AI avatar module 130 adapts its questioning based on detected indicators rather than following predetermined scripts, providing more effective probing of deception.

While the detailed description above focuses on interactive questioning through the AI avatar module 130, alternative embodiments may implement variations of the core deception detection functionality. In one alternative embodiment, the deception detection system 100 may operate in a passive analysis mode without interactive questioning, analyzing completed communications (such as written statements, recorded interviews, or email threads) to identify deception indicators and generate deception assessments. This mode may be useful for analyzing large volumes of historical communications or for applications where interactive questioning is not feasible.

In another alternative embodiment, the deception detection system 100 may integrate with existing interview or customer service platforms, providing real-time deception indicator alerts to human interviewers or agents who then conduct the follow-up questioning based on the system's recommendations. This hybrid approach combines automated deception detection with human judgment and questioning skills.

In yet another alternative embodiment, the deception detection system 100 may be configured for specific high-volume applications such as online dating profile verification, where it analyzes profile text and messaging patterns to identify potential deception in self-descriptions or stated intentions.

In a further alternative embodiment, the deception detection system 100 may be configured for continuous monitoring applications such as employee communications monitoring, where it analyzes ongoing communications (with appropriate legal authorization and employee notification) to identify potential deception related to compliance violations, conflicts of interest, or other concerns.

The deception detection system 100 provides a comprehensive AI-driven deception detection system that addresses the limitations of known approaches. By analyzing linguistic patterns specifically correlated with deception, conducting interactive iterative questioning through the AI avatar module 130, operating independently of external verification sources, and applying field-specific models, the deception detection system 100 achieves superior deception detection capabilities across diverse applications.

The deception detection system 100 distinguishes fundamentally from known content analysis systems that focus on policy violations rather than deception, from known fact-checking systems that verify factual accuracy rather than analyzing deceptive intent, and from known conversational AI systems that determine interaction intent rather than assessing truthfulness.

The technical advantages of the deception detection system 100—including higher accuracy for deception detection, progressive refinement through iterative questioning, independence from external verification, field-specific optimization, real-time operation, scalability, multimodal integration, and adaptability—make it suitable for a wide range of applications where deception detection is critical. None of the prior approaches provide a comprehensive deception detection system that: (1) analyzes linguistic patterns specific to deception across multiple communication modalities; (2) generates dynamic, context-aware follow-up questions through an AI avatar to probe inconsistencies; (3) operates in real-time during interactive sessions; (4) provides field-specific deception indicators across specialized domains; (5) distinguishes between factual inaccuracy and deceptive intent; and (6) conducts iterative analysis that progressively refines deception assessment through multiple interaction cycles.

In one aspect, a computer-implemented method for militarized deception detection in combat environments is provided. The method comprises deploying a deception detection system on a militarized humanoid or edge computing device in a combat environment, configuring the deception detection system to operate in a selectable operational mode including at least a fully autonomous mode and a human-assisted mode, receiving, by the deception detection system, a statement from a foreign national in a source language; translating the statement to a target language; analyzing the translated statement to identify deception indicators; generating follow-up questions in the target language based on identified deception indicators; translating the follow-up questions to the source language; presenting the translated follow-up questions to the foreign national; receiving responses in the source language; translating the responses to the target language; analyzing the translated responses to identify additional deception indicators; determining a deception assessment; and transmitting the deception assessment as actionable intelligence to warfighters or command personnel via a local mesh network, wherein the deception detection system operates without cloud connectivity and maintains full functionality in austere or contested environments.

In one aspect, a computer-implemented method for autonomous deception detection, is provided. The method comprises: autonomously receiving, by a computing system operating without human intervention, a statement from a subject; autonomously analyzing, by the computing system, the statement to identify one or more deception indicators comprising linguistic patterns correlated with deceptive intent; autonomously generating, by the computing system, one or more follow-up questions based on the identified deception indicators; autonomously presenting the one or more follow-up questions to the subject; autonomously receiving, by the computing system, one or more responses to the follow-up questions; autonomously analyzing, by the computing system, the one or more responses to identify additional deception indicators; and autonomously determining, by the computing system, a deception assessment based on the deception indicators identified in the statement and the additional deception indicators identified in the responses; wherein all operations are performed automatically by the computing system without requiring human intervention.

In one aspect a computer-implemented method for human-assisted deception detection is provided. The method includes receiving, by a computing system, a statement from a subject; analyzing, by the computing system, the statement to identify one or more deception indicators comprising linguistic patterns correlated with deceptive intent; providing, by the computing system, the identified deception indicators to a human operator; receiving, by the computing system from the human operator, at least one of: confirmation of the identified deception indicators, modification of the identified deception indicators, or input regarding follow-up questioning strategy; generating, by the computing system in coordination with the human operator, one or more follow-up questions based on the identified deception indicators and the human operator input; presenting the one or more follow-up questions to the subject; receiving, by the computing system, one or more responses to the follow-up questions; analyzing, by the computing system, the one or more responses to identify additional deception indicators; providing, by the computing system, analysis results to the human operator; and determining, by the computing system in coordination with the human operator, a deception assessment based on the deception indicators and the human operator input.

In one aspect a computer-implemented method for adaptive deception detection is provided. The method includes receiving, by a computing system, a statement from a subject; determining, by the computing system, an operational mode from a plurality of operational modes including at least a human-assisted mode and a fully autonomous mode; when operating in the human-assisted mode: analyzing the statement in coordination with a human operator to identify deception indicators; generating follow-up questions in coordination with the human operator; and determining a deception assessment in coordination with the human operator; when operating in the fully autonomous mode includes: autonomously analyzing the statement to identify deception indicators; autonomously generating follow-up questions; and autonomously determining a deception assessment; monitoring, by the computing system, operational conditions and performance metrics; and transitioning, by the computing system, between the human-assisted mode and the fully autonomous mode based on the operational conditions, performance metrics, or predefined criteria.

In one aspect, a computer-implemented method for distributed deception detection in edge computing environments is provided. The method includes: deploying a deception detection system across a plurality of edge devices connected via a local mesh network, wherein each edge device executes deception detection algorithms locally; receiving, by a first edge device of the plurality of edge devices, a statement from a subject; analyzing, by the first edge device, the statement locally to identify one or more deception indicators; generating, by the first edge device, one or more follow-up questions based on the identified deception indicators; presenting the one or more follow-up questions to the subject; receiving, by the first edge device, one or more responses to the follow-up questions; analyzing, by the first edge device, the one or more responses locally to identify additional deception indicators; and determining, by the first edge device, a deception assessment based on the deception indicators; wherein all deception detection operations are performed locally on the edge devices without requiring cloud connectivity.

In one aspect, a computer-implemented method for multilingual deception detection, is provided. The method includes: receiving, by a computing system, a statement from a subject in a source language; translating, by the computing system, the statement from the source language to a target language; analyzing, by the computing system, the translated statement to identify one or more deception indicators comprising linguistic patterns correlated with deceptive intent in the target language; generating, by the computing system, one or more follow-up questions in the target language based on the identified deception indicators; translating, by the computing system, the one or more follow-up questions from the target language to the source language; presenting the translated follow-up questions to the subject in the source language; receiving, by the computing system, one or more responses from the subject in the source language; translating, by the computing system, the one or more responses from the source language to the target language; analyzing, by the computing system, the translated responses to identify additional deception indicators; and determining, by the computing system, a deception assessment based on the deception indicators identified in the translated statement and the additional deception indicators identified in the translated responses.

In one aspect, a deception detection system configured for multiple operational modes is provided. The system includes at least one processor; at least one memory coupled to the at least one processor; a deception detection engine executing on the at least one processor and configured to analyze statements to identify deception indicators; a question generation module configured to generate follow-up questions based on identified deception indicators; an operational mode controller configured to: select an operational mode from a plurality of operational modes including at least a human-assisted mode, a fully autonomous mode, and a hybrid mode; configure the deception detection engine and question generation module to operate according to the selected operational mode; and transition between operational modes based on operational conditions, performance metrics, or predefined criteria; wherein in the human-assisted mode, the system operates in coordination with human operators; wherein in the fully autonomous mode, the system operates without human intervention; and wherein in the hybrid mode, the system adaptively adjusts human involvement based on real-time assessment of operational requirements.

In one aspect, a distributed deception detection system for edge computing environments. The method includes a plurality of edge devices, each edge device including: at least one processor; at least one memory storing deception detection algorithms; a mesh networking interface; wherein each edge device is configured to: execute the deception detection algorithms locally to analyze statements and identify deception indicators; generate follow-up questions based on identified deception indicators; determine deception assessments locally without requiring cloud connectivity; a local mesh network connecting the plurality of edge devices and enabling device-to-device communication without centralized infrastructure; wherein the distributed deception detection system maintains full operational capability in the absence of internet connectivity, GPS availability, or centralized computing infrastructure.

In one aspect. a computer program product for autonomous deception detection is provided. The computer program product including a non-transitory computer-readable storage medium having program instructions embodied therewith, the program instructions executable by one or more processors to cause the at least one processor to: autonomously receive a statement from a subject without human intervention; autonomously analyze the statement to identify deception indicators; autonomously generate follow-up questions based on identified deception indicators; autonomously present the follow-up questions to the subject; autonomously receive responses to the follow-up questions; autonomously analyze the responses to identify additional deception indicators; autonomously conduct iterative questioning across multiple interaction cycles; and autonomously determine a final deception assessment; wherein all operations are performed automatically without requiring human intervention.

In one aspect, a computer-implemented method for militarized deception detection in combat environments is provided. The method includes deploying a deception detection system on a militarized humanoid or edge computing device in a combat environment; configuring the deception detection system to operate in a selectable operational mode including at least a fully autonomous mode and a human-assisted mode; receiving, by the deception detection system, a statement from a foreign national in a source language; translating the statement to a target language; analyzing the translated statement to identify deception indicators; generating follow-up questions in the target language based on identified deception indicators; translating the follow-up questions to the source language; presenting the translated follow-up questions to the foreign national; receiving responses in the source language; translating the responses to the target language; analyzing the translated responses to identify additional deception indicators; determining a deception assessment; and transmitting the deception assessment as actionable intelligence to warfighters or command personnel via a local mesh network; wherein the deception detection system operates without cloud connectivity and maintains full functionality in austere or contested environments.

While specific embodiments have been described in detail, those skilled in the art will recognize that various modifications and alternatives may be implemented without departing from the scope of the invention as defined in the appended claims.

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for AI-driven deception detection, comprising:
receiving, by a computing system, a statement from a subject via at least one input modality selected from at least one of text input, speech-to-text conversion, video analysis, email, and SMS messaging;
analyzing, by the computing system using one or more processors executing deception detection algorithms, the statement to identify one or more deception indicators, wherein the one or more deception indicators comprise linguistic patterns specifically correlated with deceptive intent, including at least one of: pronoun usage patterns indicative of psychological distancing, temporal vagueness markers, narrative structure inconsistencies, lack of sensory detail, or emotional language anomalies;
generating, by an AI avatar executing on the computing system, one or more follow-up questions based on the identified deception indicators, wherein generating the one or more follow-up questions comprises dynamically generating contextually-relevant questions in real-time based on the specific type of deception indicator detected, wherein the follow-up questions are adapted to probe inconsistencies identified in the statement;
presenting, by the AI avatar, the one or more follow-up questions to the subject in real-time;
receiving, by the computing system, one or more responses to the follow-up questions;
analyzing, by the computing system, the one or more responses to identify additional deception indicators; and
determining, by the computing system, a deception assessment based on the deception indicators identified in the statement and the additional deception indicators identified in the responses.

2. The method of claim 1, wherein analyzing the statement to identify deception indicators is performed independently of external database verification, wherein the deception indicators are identified through linguistic pattern analysis of the statement itself rather than comparison to external reference sources.

3. The method of claim 1, wherein the system distinguishes between factually inaccurate statements and deceptively-presented statements, wherein a factually accurate statement may be identified as deceptive based on linguistic presentation patterns.

4. The method of claim 1, wherein the AI avatar conducts iterative questioning across multiple interaction cycles, wherein each subsequent question is generated based on deception indicators detected in responses to previous questions, creating a progressive refinement of the deception assessment.

5. The method of claim 4, wherein the iterative questioning continues until at least one of: a confidence threshold for the deception assessment is reached, a predetermined number of interaction cycles is completed, and the subject terminates the interaction.

6. The method of claim 1, wherein the deception detection is field-specific, wherein the system applies different deception detection models based on a determined context selected from a predefined list of specialized fields.

7. The method of claim 6, wherein each field-specific deception detection model comprises at least one of weighted importance of different deception indicators for that field, baseline linguistic patterns for truthful statements in that field, field-specific question templates for probing deception indicators, and threshold values for deception assessment in that field.

8. The method of claim 1, wherein the linguistic patterns comprise analysis of at least one of:
first-person pronoun usage frequency, wherein reduced first-person pronoun usage indicates psychological distancing from false statements;
temporal specificity, wherein vague temporal qualifiers indicate potential deception compared to specific temporal references;
sensory detail presence and richness, wherein lack of sensory descriptions indicates potential fabrication;
narrative structure coherence, wherein structural inconsistencies or temporal jumps indicate potential deception;
emotional language congruence with stated facts, wherein incongruent emotional language indicates potential deception;
verb tense consistency, wherein unexpected verb tense shifts indicate potential deception; and
detail level consistency, wherein uneven detail distribution indicates potential deception.

9. The method of claim 1, wherein the at least one input modality comprises multiple modalities processed simultaneously, the method further comprising:
performing speech pattern analysis on audio input to identify voice stress patterns, speech rate variations, vocal pitch changes, or speech disfluencies indicative of deception;
performing video analysis on video input to identify micro-expressions, eye movement patterns, or body language indicators indicative of deception; and
integrating deception indicators from text analysis, speech pattern analysis, and video analysis according to a field-specific model to generate the deception assessment.

10. The method of claim 1, wherein generating the one or more follow-up questions comprises at least one of:
identifying, from the deception indicators, a highest-priority indicator requiring probing;
selecting, based on a field-specific model, a question type appropriate for probing the highest-priority indicator;
generating, using a large language model, a natural language question of the selected question type; and
adapting the natural language question based on conversational context from previous interactions with the subject.

11. The method of claim 1, wherein analyzing the one or more responses to identify additional deception indicators comprises analyzing at least one of:
consistency of the responses with the original statement and with each other;
detail level of the responses compared to requested specificity;
response latency for each response;
linguistic patterns in the responses compared to linguistic patterns in the original statement;
evasiveness of the responses; and
over-specification in the responses.

12. The method of claim 1, further comprising:
determining a field or context of the interaction based on analysis of statement content, keywords, and context; and
selecting, from a field-specific model database, a deception detection model corresponding to the determined field or context, wherein the selected deception detection model is used for analyzing the statement and responses.

13. The method of claim 1, wherein the deception assessment comprises at least one of:
an overall deception score indicating likelihood of deception;
identification of specific deception indicators with associated confidence levels;
supporting evidence from the statement and responses for each identified deception indicator; and
recommendations for further investigation or action based on the deception score and field-specific model.

14. The method of claim 1, further comprising:
generating, by the computing system, a detailed report comprising: the original statement, all follow-up questions and responses, identified deception indicators with confidence levels, field-specific analysis, and the deception assessment; and
providing, by the computing system, the detailed report via an output interface.

15. The method of claim 1, further comprising:
providing, by the computing system, real-time feedback during the interaction, wherein the real-time feedback comprises at least one of: highlighting portions of the statement with high deception indicators, displaying deception scores, or alerting a system operator to areas requiring additional probing.

16. The method of claim 1, wherein dynamically generating contextually-relevant questions in real-time comprises generating and presenting questions within a response time suitable for natural conversational flow, wherein the response time is less than about 3 seconds for text-based interactions or less than about 1 second for voice-based interactions.

17. A system for AI-driven deception detection, comprising:
an input interface configured to receive statements from subjects via multiple modalities including text, speech, video, email, and SMS;
a deception detection engine comprising at least one processor executing linguistic pattern analysis algorithms specifically designed to identify deception indicators, wherein the deception indicators comprise linguistic patterns correlated with deceptive intent;
an AI avatar module configured to generate and present dynamic, contextually-relevant follow-up questions based on detected deception indicators;
a response analysis module configured to analyze responses to follow-up questions and identify additional deception indicators;
an iterative questioning controller configured to manage multiple cycles of questioning and analysis, wherein the iterative questioning controller determines when additional questioning is needed and what areas require further probing;
a field-specific model database storing specialized deception detection models for multiple fields and contexts; and
an output interface configured to provide deception assessment results.

18. The system of claim 17, wherein the deception detection engine analyzes linguistic patterns independently of external database verification, identifying deception through analysis of how statements are presented rather than verification of factual content.

19. The system of claim 17, wherein the AI avatar module comprises at least one of:
a question generation engine configured to receive deception indicator profiles and generate questions specifically designed to probe identified indicators;
a context manager configured to maintain conversational context across multiple interaction cycles; and
a presentation interface configured to present generated questions through appropriate modalities.

20. The system of claim 17, further comprising a multimodal integration module configured to combine deception indicators from text analysis, speech pattern analysis, and video analysis according to field-specific models to generate overall deception assessments.

21. The system of claim 17, wherein the AI avatar module integrates deception detection algorithms with open-source large language models, wherein the algorithms identify deception indicators and the large language models generate natural language questions to probe the identified indicators.

22. The system of claim 17, wherein the field-specific model database comprises specialized models for pre-defined fields including at least insurance claims, witness testimony, employment screening, financial fraud, relationship contexts, legal proceedings, security clearance interviews, medical history verification, academic integrity assessment, customer service interactions, investigative journalism, background checks, asylum claims, child custody evaluations, elder abuse investigations, workplace harassment claims, product liability claims, intellectual property disputes, contract negotiations, merger and acquisition due diligence, regulatory compliance interviews, and forensic accounting investigations.

23. A computer product for AI-driven deception detection, the computer product comprising a non-transitory computer-readable storage medium having program instructions embodied therewith, the program instructions executable by one or more processors to cause the at least one processor to:
receive a statement from a subject via at least one input modality;
analyze the statement using deception detection algorithms to identify deception indicators comprising linguistic patterns specifically correlated with deceptive intent;
generate, via an AI avatar, follow-up questions dynamically based on the identified deception indicators;
present the follow-up questions to the subject in real-time;
receive responses to the follow-up questions;
analyze the responses to identify additional deception indicators;
conduct iterative questioning across multiple interaction cycles, wherein each subsequent question is generated based on deception indicators detected in previous responses; and
determine a deception assessment based on deception indicators identified across all interaction cycles.

24. The computer product of claim 23, wherein the program instructions cause the at least one processor to perform deception detection independently of external database verification, analyzing linguistic patterns within statements rather than verifying factual content against external sources.

25. The computer product of claim 23, wherein the program instructions cause the at least one processor to apply field-specific deception detection models selected based on determined context, wherein different fields have different weighted importance for deception indicators.

26. The computer product of claim 23, wherein the program instructions cause the at least one processor to integrate deception indicators from multiple modalities including text analysis, speech pattern analysis, and video analysis to generate comprehensive deception assessments.

27. An iterative questioning controller for AI-driven deception detection, the iterative questioning controller comprising:
at least one processor; and
at least one memory coupled to the at least one processor, wherein the at least one memory comprises instructions which, when executed by the at least one processor, cause the at least one processor to:
receive a deception indicator profile identifying one or more deception indicators detected in a statement from a subject;
determine a priority score for each deception indicator based on at least one of: confidence level of the indicator, severity weight assigned to the indicator type in a field-specific model, criticality of information to which the indicator relates, and resolvability of the indicator through follow-up questioning;
select highest-priority deception indicators for probing based on the priority scores;
invoke an AI avatar module to generate follow-up questions targeting the selected highest-priority deception indicators;
receive an updated deception indicator profile based on analysis of responses to the follow-up questions;
determine whether additional questioning is needed based on at least one of: confidence level of current deception assessment, number of unresolved deception indicators, consistency of indicators across multiple responses, predetermined maximum number of interaction cycles, and subject termination of interaction; and
generate a final deception assessment when additional questioning is not needed.
